(19) United States
(12) Patent Application Publication
(10) Pub. No.: US 2016/0224116 A1
(43) Pub. Date: Aug. 4, 2016

(54) Systems and Methods for Non-Visual Spatial Interfacing with a Computer

(71) Applicant: Douglas Hagedorn, St. Albert (CA)

(72) Inventor: Douglas Hagedorn, St. Albert (CA)

(21) Appl. No.: 15/097,325

(22) Filed: Apr. 13, 2016

Related U.S. Application Data
(63) Continuation of application No. PCT/CA2014/050997, filed on Oct. 16, 2014.
(60) Provisional application No. 61/892,953, filed on Oct. 18, 2013.

(51) Int. Cl. G06F 3/01; G06F 3/16; G09G 5/12; G06F 3/14; G09G 3/00; G09B 21/00; G06F 3/0354

(52) U.S. Cl. CPC G06F 3/016; G09B 21/008; G09B 21/004; G06F 3/167; G06F 3/017; G06F 3/03545; G06F 3/14; G09G 3/003; G09G 5/12; G06F 2203/0331

(57) ABSTRACT

A device and method for operating a computer system without sight to explore and edit spatially portrayed data represented in a tactile format is described. Specifically, the system includes a work surface having a plurality of actuatable magnets located below the work surface. When a magnet is actuated, the magnetic field emitted from the magnet is detectable above the work surface. The presence or absence of magnetic fields above the work surface represents spatial data from the computer. The user receives the spatial data by moving a metallic implement along the work surface to detect the presence or absence of magnetic fields in various locations on the work surface. Specifically, the actuatable magnets are permanent magnets having linear actuators or servo motors for moving the magnet closer to the work surface, thereby actuating the magnet.

### RELATED APPLICATIONS

This is a continuation of International Application PCT/CA2014/050997, with an international filing date of Oct. 16, 2014, and which designated the United States, the entire contents of which are hereby fully incorporated herein by reference for all purposes. International Application PCT/CA2014/050997 claimed priority from U.S. Pat. No. 61/892,953, filed Oct. 18, 2013, the entire contents of which are hereby fully incorporated herein by reference for all purposes.

### FIELD OF THE INVENTION

The invention relates to systems and methods for allowing visually impaired people to interface with spatially portrayed data using a tactile computer interface.

### BACKGROUND OF THE INVENTION

When written descriptions are inappropriate or insufficient, pictures, diagrams and images are frequently used to convey spatial information and explain complex concepts with great clarity and utility. Many different types of information can be depicted graphically as “spatially portrayed data” by arranging shapes, lines, points, symbols, patterns and labels in a two dimensional composition. Various examples of spatially portrayed data products include maps, schematics, graphs, charts, tables, calendars, games, and graphical user interfaces. As is well known, spatially portrayed data can be used by individuals to assist in collecting, assimilating and processing information for use in their daily lives. However, access to these products is not universal, particularly for blind and visually impaired individuals who cannot see electronic screens or printed pages.

Statistics on the global prevalence of vision loss published by the World Health Organization in 2012 indicate that 285 million people worldwide live with significant vision impairment, 40 million of whom are completely blind (Pascolini and Mariotti 2012). Without sufficient access to spatial information, the capacity for independent mobility, meaningful employment, geographic learning and communication concerning spatial concepts may be seriously reduced for non-sighted people, who cannot use traditional visual media.

In 2005, the Canadian National Institute for the Blind [CNIB] documented a number of direct implications to social integration, employment levels, education, mobility, and recreational opportunities that stem from the unmet needs of non-sighted people. Spatial awareness is fundamental for success in these areas and many currently inaccessible spatially portrayed data products are necessary tools to fulfill these unmet needs (Rowell and Ungar 2005).

Research concerning information communication technologies that can be leveraged to serve people who are visually impaired has emerged from many fields, including Computer Science, Engineering, Pedagogy, Occupational Therapy, and Geographic Information Science. Scholars in these fields have collectively asserted the need for an integrated platform that facilitates a new type of human computer interface that emphasizes direct interaction with alternative representations of information. Existing technologies that facilitate this type of interaction are not yet viable, particularly when tasked with displaying complex scenes such as maps and geographic information. In visual contexts, maps are often designed to depict multiple coincident layers of information. Unfortunately, basic map layering techniques such as variable opacity, superimposition, and congruence often have no useful analogue in non-visual formats.

The institutional implications of inaccessible spatial information are substantial. Professor Reginald Golledge (1993), an adventitiously blind geographer, asserted in a survey of Geography and the Disabled that individuals with impaired sensory apparatus live in a transformed or distorted space that is experientially very different in its demands and challenges than what is experienced by sighted populations. The disconnect between traditional constructions of spatial information and this transformed world is immense and must be bridged in order to achieve more equitable, meaningful, and universal discourse. Pow (2000) posits that “the persistence of visual ideology is problematic as it encourages geographic scholarship to neglect the role of non-visual senses, while at the same time, marginalizes the experiences of non-sighted people (p.166)”. Wies et al. (2001) assert that the inaccessibility of instructional materials, media and technologies used to promote spatial education hinders the abilities of students with little or no sight to excel and freely pursue technical careers. These same educational barriers deny the world access to this potential pool of talent. Challis (2000) also notes that people with unimpaired sight may also experience situations of restricted vision, such as power outages, fog, or smoke and the potential value of non-visual information formats is generally overlooked in these instances.

As professionals whose mandates promote building spatial awareness, accessibility technologists are called upon to provide skills and tools that can illuminate the unique nature of a visually inaccessible world to both the non-sighted and sighted alike. However, these goals have not yet been reached (Vidal-Verdu and Hafez 2007) and non-visual information representation has often been seemingly marginalized by advances and pressing problems in other areas of information and communications technology (ICT) research (Perkins 2002).

In the context of spatial data accessibility, vision impairment and blindness are conditions of particular significance for those whose lives are made more difficult by the intense emphasis on visual media in contemporary society. As such, there is a need for technology that will contribute to the improvement of map accessibility for non-sighted people by examining factors that prevent universal access to spatially portrayed data and impede the developmental progress of non-visual technologies.

A review of the prior art reveals several devices and systems for depicting information without visual representation and/or allowing user interaction with a device through the use of tactile feedback, haptic cues, auditory information, and/or physical deformation of surfaces.

U.S. Pat. No. 7,339,578 to Hafez et al. describes a display technology with a flexible touch surface that can be altered or deformed by the activation of electromagnetic hardware embedded underneath. In this system, which comprises multiple stacked hardware layers, a flexible touch surface is affixed to an array of independently mobile metal blades that are cut into a sheet of ferrous metal underneath. An insulating layer below the metal blades provides recesses or cavities that each blade can move into when attracted by an activated magnetic field. The lower most layers of the system is an array of pancake coils, and associated circuitry, that can be selectively addressed and energized to create a localized magnetic field. When a magnetic field is created by the pancake coil situated beneath a particular metal blade, the blade will be pulled into the recess, thereby deforming the uppermost flexible touch surface.

U.S. Pat. No. 8,203,529 to Rogowitz et al. teaches a device that creates a tangible surface topography on a tactile display by altering the height of an array of linear actuator pins that extend from the display's surface.

U.S. Pat. No. 7,009,595 to Roberts et al. describes a system through which data can be spatially portrayed as tangible output on a refreshable tactile display. This display creates discrete tactile features by selectively raising or lowering a selection of adjacent pins that are arranged within a grid array. The head of each pin is affixed to a flexible elastic membrane that can deform to create a continuous undulating surface across which raised line style tactile images can be rendered.

U.S. Patent Application Publication No. 2010/0192110 to Carter et al. describes a device that allows visually impaired users to explore a virtual model of a 3D environment by moving a figurine or artifact style avatar within the boundaries of a planar display surface, such as a desk or tabletop or tablet surface. The tracked movement of the physical avatar within the display surface is mirrored by the movement of a virtual probe that interacts with features within the 3D software model. When the user moves their avatar figurine, and thus the virtual probe as well, to a location within the 3D model that is in close proximity to a virtual feature, then haptic or audio output is provided to describe the spatial relationship between the probe/avatar and the virtual feature.

U.S. Patent Application Publication No. 2008/0010593 to Uusitalo et al. teaches a human computer interface mechanism that creates raised line tactile features on the surface of a touch sensitive display. With this technology, a device can refresh and modify its physical form to match the arrangement of features on the screen display. For example, raised patches could be deployed to create a tangible representation of a virtual button displayed on the screen. This functionality is achieved using piezoelectric actuators or expandable pouches embedded within a layered transparent flexible membrane adhered to the display surface.

U.S. Pat. No. 8,135,577 to Seymour et al. describes a device intended to transform text content embedded in a graphical user interface environment into Braille output. This technology uses software that parses on-screen text and digitally translates that text into Braille characters to be displayed in a tactile format on a pin based Braille display.

U.S. Pat. No. 8,063,892 to Shahoian et al. describes a haptically enhanced touch surface that facilitates the control of a pointer or cursor within a graphical user interface environment. In this system, a standard touch sensor is augmented with actuators that can change the tangible characteristics of the sensor apparatus when the user's finger is moved.

U.S. Pat. No. 7,788,032 to Moloney describes a mobility assistance device that allows a user to orient and navigate to a target location by following haptic cues that indicate the required path of travel. Such a device would be capable of independently determining the user's position and orientation in relation to a desired target using technologies such as GPS, gyroscopes and accelerometers.

U.S. Pat. No. 7,728,820 to Rosenberg et al. describes a computer interface system architecture that allows a user of a computing device to receive different types of tactile feedback when operating a touchpad. This system comprises mainly of a) a planer touch surface that identifies the location of a user's finger within a fixed frame of reference; b) a microcontroller or CPU that coordinates the inflow of touch data from the touch sensor and the user's activities and the output of haptic signals that trigger actuator devices; and c) various haptic actuator devices that are capable of creating physical sensations that the user can perceive as kinesthetic events.

U.S. Pat. No. 7,636,080 to Rosenberg et al. describes a system in which multiple computers and peripheral devices are interconnected using peer-to-peer networking technologies in a manner that enables the transmission of force-feedback actions between users at different computer terminals. When a user at one computer applies force to an effector, that consists of both force tracking and force creating mechanisms, those forces are then transmitted to and recreated by an identical device operated by another user.

U.S. Patent Application Publication No. 2011/0210926 to Pasquero et al. describes a system wherein a portable electronic device detects a query gesture performed by a user as fingertip movement on a touchscreen and then activates an actuator to create a form of tactile feedback in response, such as vibrations or pulses.

U.S. Patent Application Publication No. 2010/0231541 to Cruz-Hernandez et al. teaches a system that allows users of mobile phones and other computing devices to interact with a graphical user interface augmented by a haptic output system that creates the sensation of authentic textures or other haptic effects when a target portion of the display screen is touched by the user.

The foregoing prior art shows there is a need for an integrated, compact, and low-energy computer device that provides a dynamic tactile interaction method suitable for maps and other forms of complex spatial data. There is a need for a computer of this type to allow users to explore and edit spatially portrayed data using an interactive display mechanism that does not rely exclusively on direct contact with a tactile work surface that physically deforms. Moving away from tactile display mechanisms that change the shape and texture of their output surface enables user to interact with the display surface by placing objects or markers within the represented scene. This technique creates layered information structures without occluding the tactile display output rendered underneath the object/marker.

### SUMMARY OF THE INVENTION

In accordance with the invention, there is provided a device for allowing a user to interface with spatial data. The device generally comprises an enclosure having a top side with a work surface for displaying spatial data; an array of independently actuatable magnets located below the work surface for representing the spatial data as magnetic fields detectable by the user at the work surface; and a control system operatively connected to the array of independently actuatable magnets for controlling the actuation of each magnet.

In one embodiment, the magnets are permanent magnets and each magnet further comprises a linear actuator for actuating the magnet by moving the magnet closer to the work surface. The linear actuators may be servomechanisms or solenoid switches.

In another embodiment, the device further comprises a magnetic implement for enabling the user to detect magnetic fields at the work surface. The magnetic implement may be worn on the user's finger. The magnetic implement may be a removable finger pad, a finger cot, and/or a metallic stylus.

In yet another embodiment, the work surface of the device further comprises a visual display for providing visual information at the work surface.

In one embodiment, the device comprises an audio input system operatively connected to the control system for receiving voice commands from a user, wherein the control system interprets the voice commands to alter the display of spatial data.

In another embodiment, the device comprises an audio output system operatively connected to the control system for providing audio output to the user, wherein the control system generates audio output information based on the display of spatial data and the position of the user's hand at the work surface. The audio output system may include stereo sound operatively connected to the control system for providing stereo sound output to the user, wherein the control system generates stereo sound based on the display of spatial data and the position of the user's hand at the work surface.

In yet another embodiment, the device comprises a motion capture system operatively connected to the control system for capturing the movement of the user's hand over the work surface, wherein the control system provides further output information to the user based on the position of the user's hand.

In a further embodiment, the device comprises a Braille display operatively connected to the control system for providing textual non-visual information to the user related to the display of spatial data.

In yet another embodiment, the device comprises a haptic feedback system operatively connected to the control system and to the work surface for providing haptic feedback to the user at the work surface based on the position of the user's hand. The haptic feedback system may provide haptic feedback to the user when the user's hand is located on a horizontal or vertical axis in line with a point of interest.

In one embodiment, the device further comprises control buttons operatively connected to the control system for allowing the user to provide commands to the control system.

In a further embodiment, each magnet is positioned on a ferrous plate or cup to redirect the magnet's magnetic field.

In one embodiment, the device further comprises a computer system having a second display operatively connected to the device for allowing a second user to monitor the display output on the work surface and to input data into the computer system for display on the work surface.

### BRIEF DESCRIPTION OF THE DRAWINGS

The invention is described with reference to the accompanying figures in which:

FIG. 1 is a schematic front view of a system enabling non-visual spatial interaction with a computer in accordance with one embodiment of the invention.

FIG. 2 is a schematic top view of the system in accordance with one embodiment of the invention.

FIG. 3 is a schematic top view of a magnetic tactile display in accordance with one embodiment of the invention.

FIG. 4 is a schematic front sectional view of a magnetic tactile display and work surface showing one magnet in an ON position and a second magnet in an OFF position in accordance with one embodiment of the invention.

FIG. 5 is a schematic top view of a magnetic tactile display showing a spatial pattern represented by an array of magnets in accordance with one embodiment of the invention.

FIG. 6A is a schematic top view of a map showing points on the map representing spatial data that can be conveyed using the magnetic tactile display in accordance with one embodiment of the invention.

FIG. 6B is a schematic side view of the device showing a plurality of magnets in the ON or OFF position for portraying spatial data detectable above a work surface by a user having a metallic implement on their finger in accordance with one embodiment of the invention.

FIG. 6C is a top view of a user's hand holding a metallic stylus in accordance with one embodiment of the invention.

FIG. 6D is a side view of a finger cot with an embedded magnetic prove on a user's finger in accordance with one embodiment of the invention.

FIG. 7 is diagram of the control system for the device showing input and output devices in accordance with one embodiment of the invention.

FIG. 8A is a front view of a magnet showing the magnet's natural magnetic field.

FIG. 8B is a front view of a magnet in a ferrous cup showing the redistribution of the magnetic field due to the ferrous cup in accordance with one embodiment of the invention.

FIG. 9 is a top view of a work surface illustrating a horizontal and vertical vibrotactile guideline for assisting a user in locating a target feature of interest in accordance with one embodiment of the invention.

FIG. 10A is a front view of the device configured on a pedestal in accordance with one embodiment of the invention.

FIG. 10B is a front view of the device mounted on a wall in accordance with one embodiment of the invention.

### DETAILED DESCRIPTION OF THE INVENTION

With reference to the figures, a device 10 for allowing visually impaired users to interface with spatially portrayed data in a computer system is described.

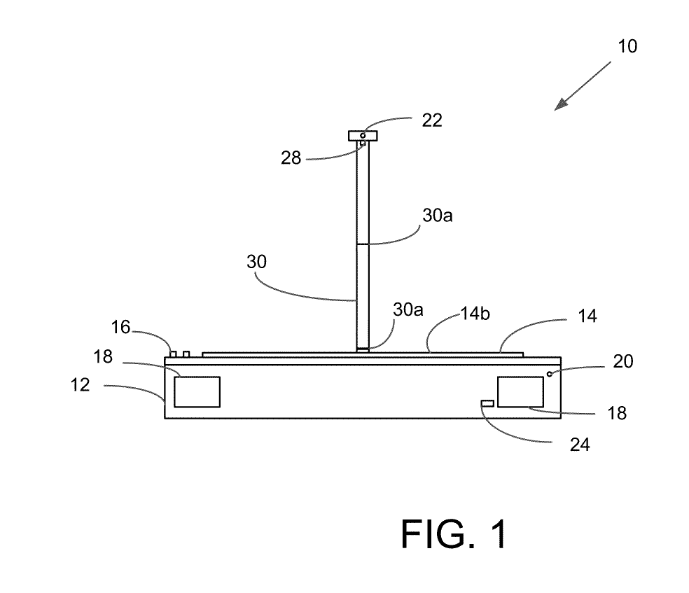

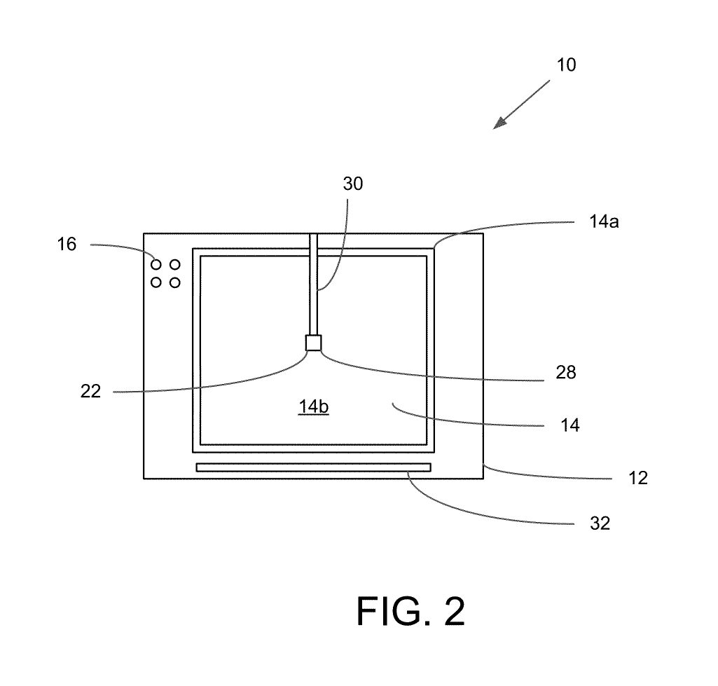

Referring to FIGS. 1 and 2, the device 10 generally comprises an enclosure 12 having a work surface 14 on the top of the enclosure, control buttons 16, a speaker 18, a headphone port 20, a USB port 24, and a Braille display 32. An armature 30 is attached to the top of the enclosure and provides support for a motion capture device 28 and a microphone 22. The armature may have hinges 30a to be articulated or detachable to facilitate more compact travel and storage of the device.

The work surface 14 serves as the primary interface for a user to spatially interact with the device. As explained in greater detail below, as a user moves their hand or finger over the work surface, they receive different types of feedback based on the location of their hand. Preferably the work surface comprises a display screen, such as an LCD display screen with a backlight that provides visual information for users who have partial sight available. It is not necessary that the work surface remain level in a horizontal plane as ergonomics may dictate that a work surface that is tilted towards the user is more comfortable. In some embodiments of this system the work surface is an embossed or relieved non-magnetic material that is white or light-colored to allow images and/or words to be clearly projected onto the work surface from a video projector mounted overhead (not shown). The work surface is surrounded by a physical border 14a that provides a referential landmark for the user's hand. In some embodiments, a clip or bracket is integrated into the surrounding border surrounding to retain single page tactile printouts that are placed on top of the work surface.

### Magnetic Tactile Display

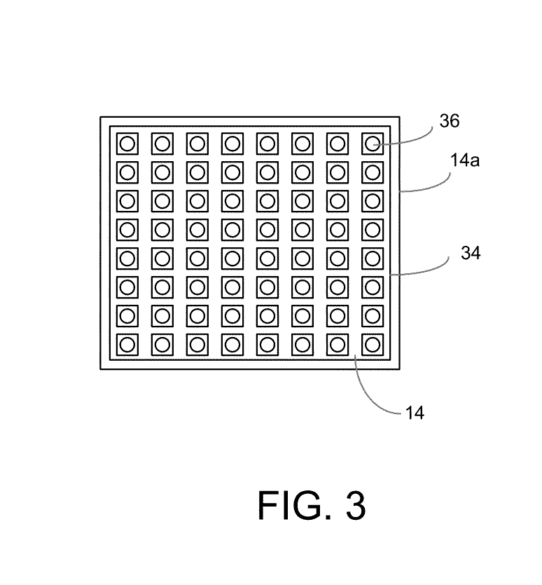

Referring to FIG. 3, the device further comprises a magnetic tactile display 34 located below the work surface in the enclosure which comprises a two dimensional array of actuatable magnets 36. Preferably, the array of actuatable magnets form pixels that are arranged in a grid pattern, such as in FIG. 3 where for the purposes of illustration, the magnetic pixels are arranged in a 8×8 grid. Any number of magnetic pixels may be used, and preferably at least 121 pixels arranged in a minimum 11×11 grid are used in order to provide sufficient display resolution and a meaningful coordinate system. Each magnet is independently actuatable between an ON and OFF position, wherein in the ON position, a magnetic field from the magnet is detectable on a top side 14b of the work surface 14, and in the OFF position, the magnetic field is not detectable on the top side of the work surface.

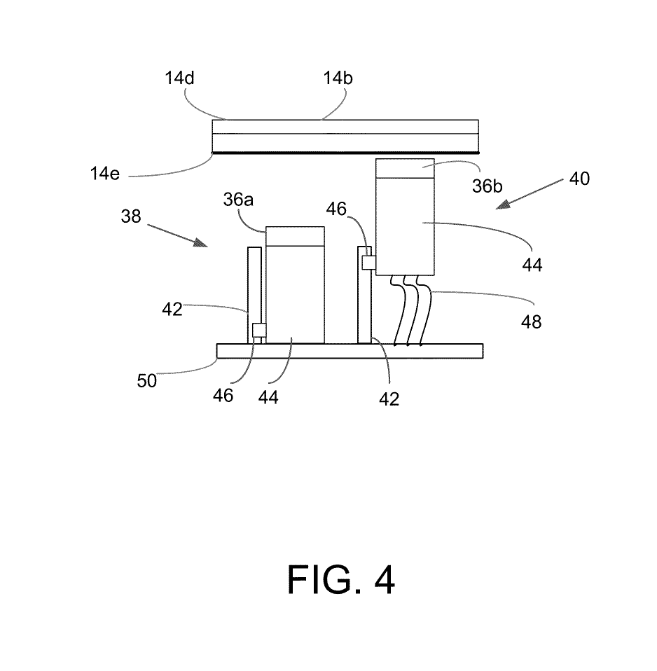

Preferably, the actuatable magnets are permanent magnets that are physically moved closer to a bottom side 14c of the work surface in the ON position, and physically moved away from the bottom side of the work surface in the OFF position. FIG. 4 illustrates a side view of a first actuatable magnet 36a on the left in an OFF position, and a second actuatable magnet 36b on the right in an ON position. In the OFF position, a magnetic field from the first magnet 36a would not be detectable on the top side 14b of the work surface, as the magnetic field decays in the void between the magnet and the work surface.

In one embodiment, each magnet 36 is moveable between the ON and OFF position by a linear actuator, which may be a linear servo motor or a latching solenoid. FIG. 4 illustrates a first and second magnet actuator unit 38, 40 attached to the first and second magnet 36a, 36b. Each magnet actuator unit generally includes a mounting chassis 42, a linear servo 44 having a motor (not shown), a horn 46 connected to the linear servo 44 and movable along the mounting chassis, a wiring harness 48, and a control PCB 50. The first magnetic actuator unit 38 is in the OFF position (not actuated), wherein the linear servo 44, horn 46 and magnet 36a are in their lowest position. When the linear servo is actuated, the linear servo and horn move up into their highest position, moving the magnet 36b up into the ON position.

Each magnet has its own linear servo motor that is independently actuatable. The use of a linear servo motor allows the magnet system to operate using a low current, and thus the wiring to each switch does not require much space or energy, allowing the system to be reasonably compact and energy efficient.

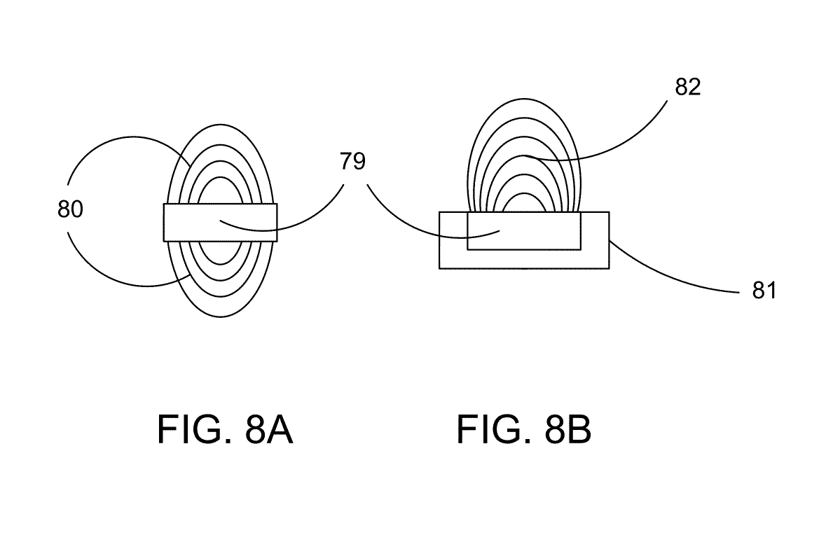

Preferably, the magnets are permanent rare earth magnets made from alloys of rare earth elements such as neodymium (Nd₂Fe₁₄B). Rare earth magnets are stable, compact and strong, enabling a small magnet to be used that has a strong enough magnetic field for a user to perceive on the work surface. A protective surface treatment such as gold, nickel, zinc, tin plating, and epoxy resin coating may be applied to the magnet to provide corrosion protection and prevent chipping. In some embodiments, individual magnets may be stacked to increase the emanating magnetic field strength. In another embodiment, as FIGS. 8A and 8B illustrate, rare earth magnets 79 are placed inside a ferrous cup 81 or against a ferrous backing plate to redirect the magnet's natural field 80 into a stronger more isolated distribution 82.

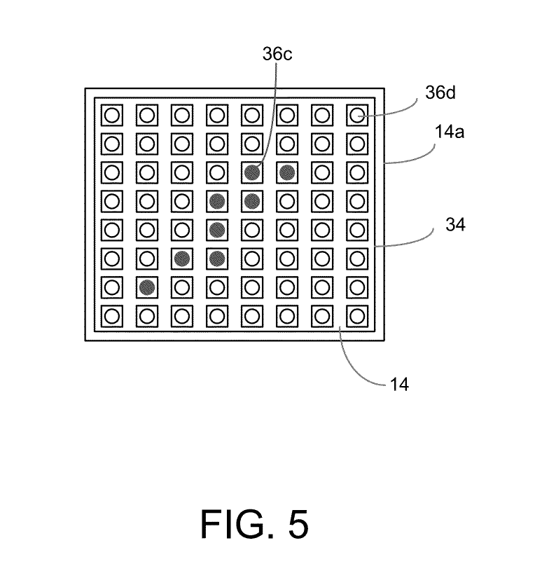

The magnetic tactile display 34 is operably connected to the computer system which controls the position of each magnet for forming a variety of patterns in the magnetic array. FIG. 5 illustrates a pattern on the magnetic array, wherein the shaded magnets 36c are in the ON position and detectable by the user at the work surface, while the unshaded magnets 36d are in the OFF position and undetectable by the user.

The magnetic tactile display has been described and illustrated as using linear servo-motors, but as is understood by those skilled in the art, other types of solenoid, actuator or magnetic switches could be used.

### Magnetic Probe Implement

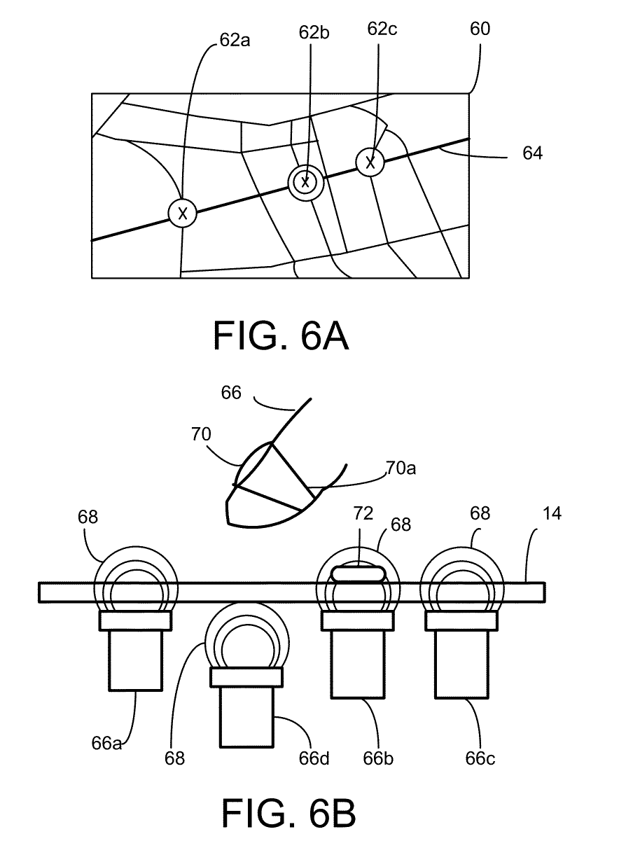

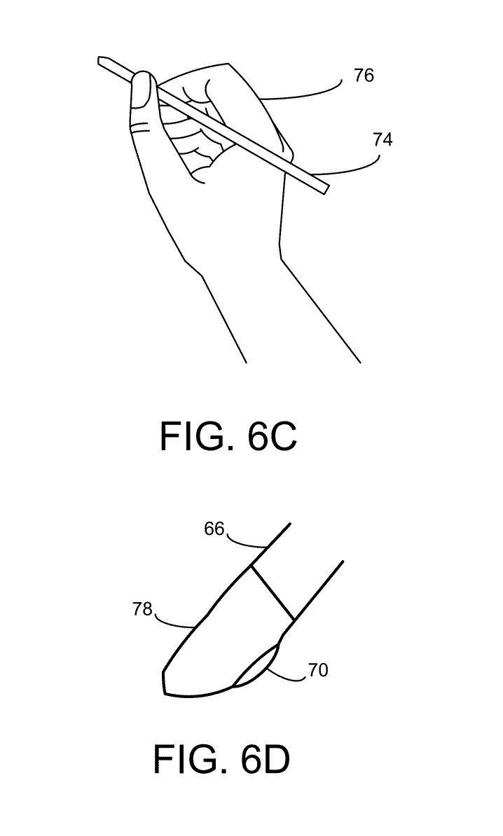

For a user to sense the magnetic fields output by the magnetic tactile display, a magnetic probe 70 that is sensitive to magnetic forces is attached to the user's finger(s) 66 or held in the user's hand. In one embodiment, shown in FIG. 6B, the magnetic probe is a rare earth magnet embedded into an apparatus 70a that a user can wear on their fingertip. Preferably the embedded magnet is positioned overtop the user's fingernail so that magnetic field from the magnet extends down through the finger. The polarity of the embedded magnet is oriented to match the polarity of the magnets 36 within the tactile display 34 so as to amplify the interaction of the tactile display and finger apparatus. As a user moves his or her finger across the work surface 14, the magnetic probe implement allows the user to detect points of magnetic attraction or repulsion.

In an alternate embodiment, shown in FIG. 6C, a user holds a metallic stylus 74 in their hand 76 and uses the stylus to explore the work surface 14 and the magnetic arrangements of spatial data generated by the magnetic tactile display 34.

In a further embodiment, a flexible metallic layer is attached to the pad of a user's finger to form the magnetic probe. In this embodiment, the user's finger pad is coated with a thin layer of liquid latex, and then iron particles are bonded into the latex layer and sealed with a second top coat of liquid latex. After use the latex/iron pad can easily be peeled from the fingertip. The latex/iron pad may be pre-formed as a finger cot or condom that a user can individually place over a finger or may be made in-situ by the user each time they interact with the system. FIG. 6D illustrates a finger cot 78 with an integrated magnetic probe 70 slipped on over a user's finger 66.

In one embodiment, magnetic implements are worn on multiple fingers to allow the user to sense the location of more than one magnet in an ON position simultaneously. Similarly, a metallic layer may be applied on the fingers of both of the user's hands to allow the user to simultaneously receive spatial feedback through both hands.

In another embodiment, a latex and iron molded patch can be adhered to the user's finger like a bandage. In another embodiment, a glove having multiple metal patches located in different areas of the glove may be worn by the user.

### Computer System

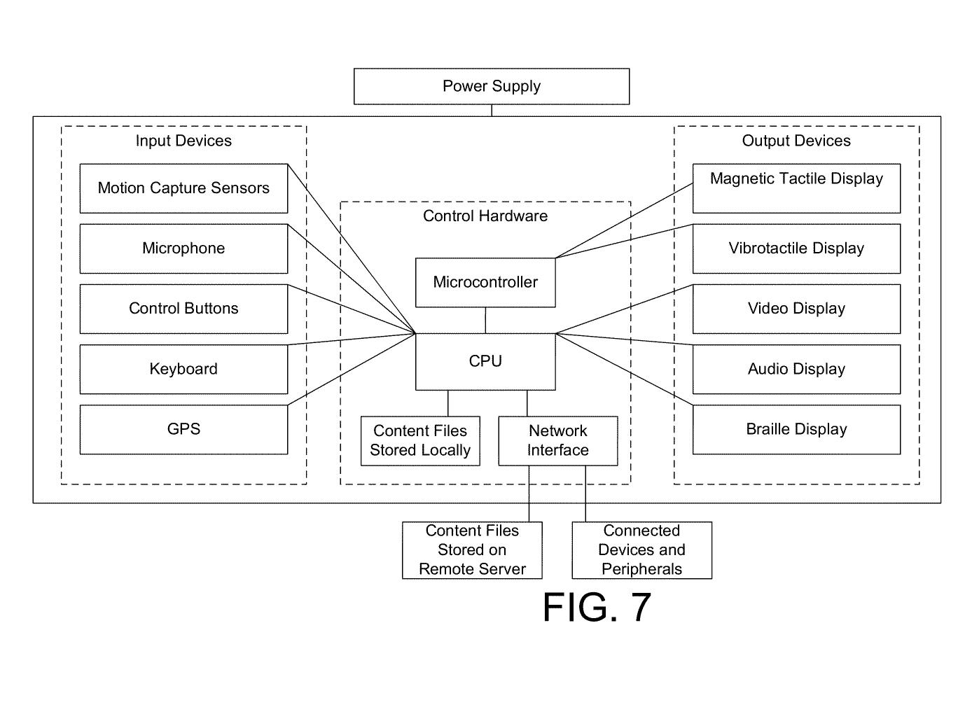

The device is operatively connected to a computer system that stores and runs all relevant associated files, drivers and interfaces for operation of the device and enables user access to interface readable files. In particular, files having system functionality will be programmed to cause a desired output to be transferred to the magnetic tactile display. FIG. 7 illustrates the computer system and the input and output devices.

In some embodiments, operating files and content files containing spatially portrayed data scenes are stored locally on a hard drive or portable memory device while other files may be stored remotely on an online server. In this case the computer provides a broadband connection that allows for internet based file transfer.

Preferably, the computer system is built into the enclosure 12. However the device may also be connected to a peripheral device such as a separate computer, i.e. a desktop or laptop computer, or a smartphone, tablet computer or similar mobile device. In some embodiments, a docking apparatus is integrated into the base display to facilitate the connection of mobile devices.

In some embodiments, a wireless tablet computer or personal mobile device connects to the built in computer system by known telephony and radio frequency (RF) protocols in order to serve as a remote control mechanism for the system. This configuration allows the system user to collaborate with a peer or colleague. For instance, while the system user explores tactile content on the display, the non-user can monitor the display output and the user's exploration paths from the tablet computer. Additionally, the tablet computer can be used to sketch new content that is then transmitted to the display device for the user's exploration. In this configuration, the system serves the role of a white board or note pad, such as would be used by teachers and students in a typical classroom for instance, where concepts and content designs can be rapidly developed and exchanged among multiple observers.

### Speakers & Microphone

In one embodiment, the microphone 22 is connected to the device to enable audio input to use with voice recognition software. The user may operate the device through voice commands.

In one embodiment, a speaker 18 is connected to the system to enable audio output. Alternatively, an audio headset can be connected to the headphone port 20 for audio output. It is understood that a speaker or audio headset could be connected via cable or wireless connection. In some embodiments audio output may be provided in stereo or surround sound such that sound output provided by the device is localized in a way that reflects the position of the digital feature being explored. For instance, an audio cue associated with a feature located on the left side of the work surface may play more loudly through the left audio channel. Audio output may be used in conjunction with the voice recognition software to confirm commands given by the user and to inform the user of the operations being performed. Audio output may also be used to provide the user with information based on the position of their hand on the work surface. For instance, when a user locates a data feature represented by a point of magnetism, a voice command can be used to prompt the computer to announce grid coordinates of the user's finger's location.

### Video Display Mechanism

Preferably, the work surface includes a liquid crystal display (LCD) screen 14d or alternative technology, such as AMOLED or E-ink display, and a backlight 14e, as shown in FIG. 4, for visual display on the work surface of images and/or text. Alternatively, a digital video projector may be positioned above the work surface to display images and/or text onto the work surface. This feature is important for user's who may have partial vision and for non visually-impaired people who may be working with a visually impaired person, for example in an educational setting.

### Computer Vision System

In one embodiment, the motion capture device 28 is mounted overhead the work surface to track and/or record the movement of a user's magnetic probe implement over the work surface. Preferably, the motion capture device is a video camera. Methods for tracking point motion using cameras are well known to those skilled in the art.

In one embodiment, the user's hand or finger is fitted with a signal device that is detected by the motion capture device overhead. The motion capture device may be an infrared camera and the signal device may be an infrared LED.

In one embodiment a capacitive or resistive touch sensor layer is adhered to the top of the work surface. In this embodiment, the user's finger is required to make contact with the work surface in order to register its location and movement.

In another embodiment, the computer includes software for translating the movement of the user's hand into the movement of a digital image or animation, such as a digital sprite, within a virtual map scene. There may be a soundscape of audio features within the map scene that can be explored by the user moving his or her hand within the map field. When a point of interest, typically co-located with a magnetic landmark, is “touched” by the sprite, an audio clip or string of synthesized speech output describing the feature is played over speakers or through the user's headphones.

In another embodiment, the user's hand movements over the work surface are monitored in order to provide the equivalent of cursor movement back to the computer system, providing an understanding of the user's hand movements over the work surface.

By detecting user hand movement from overhead, tactile content and tangible markers or memory aids can be placed below a user's fingers without impeding the sensors that enable the hand tracking functionality. Markers of this sort can be tagged with QR codes or other forms of fiducial symbol that are recognized by the computer vision system to provide discrete tracking and dynamic identification of all markers placed within the scene.

### Haptic/Vibrotactile Output Device

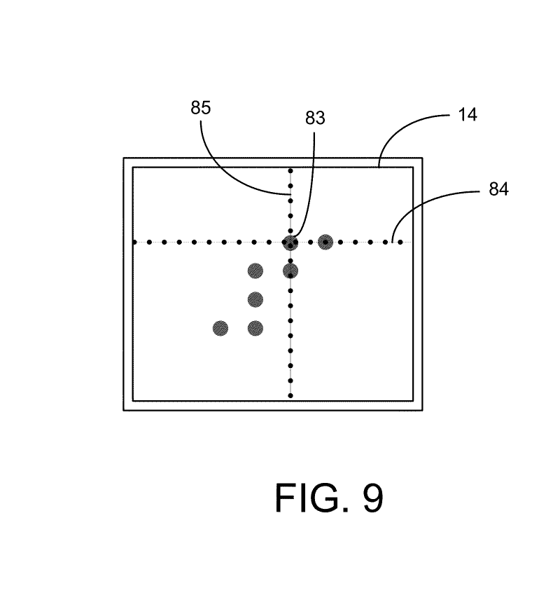

In one embodiment, one or more transducer mechanisms that provide haptic output via vibration may be used to create an additional layer of perceptible somatosensory information as the user explores an interactive scene. Preferably the mechanism that provides vibrotactile output is embedded into the magnetic probe apparatus, but in certain embodiments it may be integrated into the work surface or enclosure. An illustration of the operation of this mechanism is given using a crosshair guideline example FIG. 9. Quite often, when exploring tactile scenes with the tip of single finger it can be quite difficult to find the precise location of a desired point of interest. Aligning digital guidelines along a horizontal axis 84 and vertical axis 85 of a selected feature 83 can accelerate the location of that feature. When a user passes over either guideline they will feel a vibration that denotes the presence of the feature in line with their finger and hear an audio cue that identifies the orientation of the guideline. The user can then travel along the vibrotactile guideline or move in reference to it to reach the location of the feature.

### Control Buttons

The base display system may include a number of integrated control buttons 16, keys or switches that can be used to operate the system. Control buttons are embedded in the device enclosure 12 and arranged on the periphery of the work surface 14 such that the user can explore tactile content with one hand and operate the control buttons with the other hand.

### Braille Cell Display

In some embodiments, a Braille Cell Display 32 may be integrated or connected externally to provide an alternate form of textual information output, particularly for users who may be deaf blind. This technology may be embedded into the top surface of the device enclosure 12 around the periphery of the work surface or it could be provided as a connected peripheral device.

Method for Interaction with the System

The user may use various means for interfacing with the system. For example, the user may use keyboard commands, press purpose specific control buttons, perform hand or finger gestures that are recognized by the motion capture system or use voice commands to initiate interaction with the computer. Such commands may direct the computer to navigate to and load specific files or perform specific tasks and operations.

For the purposes of illustration, referring to FIG. 6A, this may be a subway map 60, in which train stations 62a, 62b and 62c are spatially separated from one another along a subway line 64. The commuter subway map file is programmed such that the spatial layout of each train station will be correspondingly identifiable as a magnetic field on the work surface 14 with a user's finger 66 as the finger passes over a corresponding location on the work surface. FIG. 6B shows magnets 66a, 66b and 66c in an ON position to spatially correspond respectively to subway stations 62a, 62b, and 62c. The magnetic field 68 for the ON magnets extends above the work surface 14 such that the user feels a magnetic tug when they pass their finger 66 with a metallic implement 70 through the magnetic field. The magnetic field of a fourth magnet 66d in the OFF position does not extend above the work surface and is not felt by the user.

When the user passes over a subway station represented by a magnetic field, they may also receive audio feedback from the speakers or headset identifying the station. Additionally, they may also receive audio information that is relevant to the station, including menu options for accessing additional information using voice and/or finger commands.

If a user wants to mark a specific place on the work surface, such as station 62b, they can place a marker 72 on the work surface above the corresponding magnet. The marker does not interfere with the magnetic field and does not impede the user from detecting the magnetic field.

In one embodiment, an image of the commuter subway map is displayed or projected onto the work surface.

### Use of the Device

This device can be widely used in a variety of different contexts for both visually-impaired users and their peers in academic, professional, and domestic contexts and both public or private venues. The device allows users to both access and create digital content that can be shared among a group of people.

In particular, the device can be used in an educational setting for teaching spatial concepts, such as diagrams, maps, tables and graphs, to visually-impaired students. Traditional methods for creating non-visual study materials like tactile maps and Braille documents can be difficult and time-consuming for teachers, particularly for those who do not know Braille well or are constrained by limited budgets and time. For example, the device can be used in lieu of a tactile map depicting the locations and attributes of capital cities, the structure of chemical compounds, the periodic table of the elements, the products of mathematical equations, or nutrition guidelines.

The device can be used to interface with external devices connected via telephony protocols that are known to those skilled in the art to provide direct control of multiple devices from one familiar interface. Examples of such external devices could include domestic appliances (e.g. a household thermostat, stove, washing machine, security system or home theatre equipment), retail technologies (e.g. point of sale systems, vending machines, or product catalogues) or industrial equipment (e.g. robotic assembly controls, laboratory sensors, or printing devices).

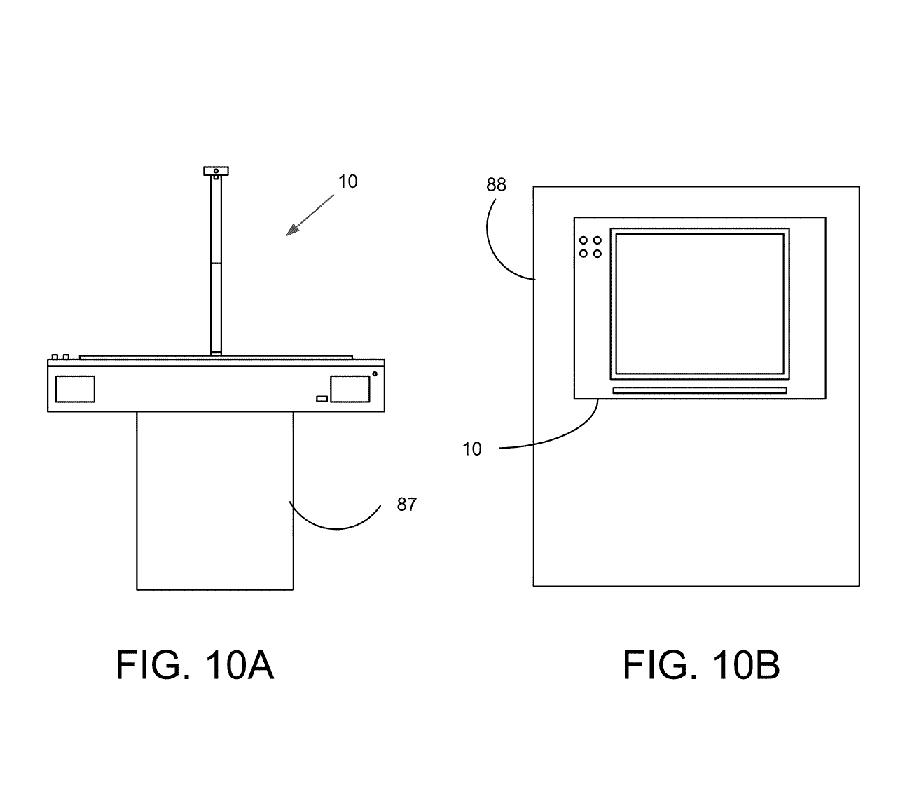

The device can be used in a public setting, such as a shopping mall, event venue, transit hub, office building, to provide a floor plan, seating directory information, or other information. When used in this context, the form factor of the device may be modified as shown in FIGS. 10A and 10B to facilitate mounting the device 10 on a pedestal 87 or flush against a wall 88.

Although the present invention has been described and illustrated with respect to preferred embodiments and preferred uses thereof, it is not to be so limited since modifications and changes can be made therein which are within the full, intended scope of the invention as understood by those skilled in the art.

### REFERENCES CITED

Challis, B. (2000). Design Principles for tactile communication within the human-computer interface. Doctor of Philosophy, University of York.

Golledge, R. (1993). “Geography and the disabled: a survey with special reference to vision impaired and blind populations.” Transactions of the Institute of British Geographers 18(1): 63-85.

Pascolini, D., & Mariotti, S. P. (2012). Global estimates of visual impairment: 2010. British Journal of Ophthalmology, 96(5), 614-618.

Perkins, C. (2002). “Cartography: Progress in Tactile Mapping.” Progress in Human Geography 26.

Pow, C. P. (2000). “Sense and Sensibility”: Social-spatial Experiences of the Visually-impaired in Singapore. Singapore Journal of Tropical Geography, 21(2), 166-182.

Rowell, J. and S. Ungar (2005). Feeling Our Way: Tactile Map User Requirements—A Survey. International Cartographic Conference. A Coruna, Spain, International Cartographic Association.

Vidal-Verdu, F. and M. Hafez (2007). “Graphical tactile Displays for Visually-Impaired People.” IEEE Transactions on Neural Systems and Rehabilitation Engineering 15(1): 11.

Wies, E., M. S. O'Modhrain, et al. (2001). Web-based touch display for accessible science education. Lecture Notes in Computer Science, Springer Berlin/Heidelberg. 2058/2001: 52-60.

1. A device for allowing a user to interface with spatial data comprising:
an enclosure having a top side with a work surface for displaying spatial data;
an array of independently actuatable magnets located below the work surface for representing the spatial data as magnetic fields detectable by the user at the work surface; and
a control system operatively connected to the array of independently actuatable magnets for controlling the actuation of each magnet.

2. The device of claim 1 wherein the magnets are permanent magnets and each magnet further comprises a linear actuator for actuating the magnet by moving the magnet closer to the work surface.

3. The device of claim 2 wherein the linear actuators are servomechanisms.

4. The device of claim 2 wherein the linear actuators are solenoid switches.

5. The device of claim 1 further comprising a magnetic implement for enabling the user to detect magnetic fields at the work surface.

6. The device of claim 1 wherein the work surface further comprises a visual display for providing visual information at the work surface.

7. The device of claim 1 further comprising an audio input system operatively connected to the control system for receiving voice commands from a user and wherein the control system interprets the voice commands to alter the display of spatial data.

8. The device of claim 1 further comprising an audio output system operatively connected to the control system for providing audio output to the user and wherein the control system generates audio output information based on the display of spatial data and the position of the user's hand at the work surface.

9. The device of claim 8 wherein the audio output system includes stereo sound operatively connected to the control system for providing stereo sound output to the user and wherein the control system generates stereo sound based on the display of spatial data and the position of the user's hand at the work surface.

10. The device of claim 1 further comprising a motion capture system operatively connected to the control system for capturing the movement of the user's hand over the work surface and wherein the control system provides further output information to the user based on the position of the user's hand.

11. The device of claim 1 further comprising a Braille display operatively connected to the control system for providing textual non-visual information to the user related to the display of spatial data.

12. The device of claim 1 further comprising a haptic feedback system operatively connected to the control system and to the work surface for providing haptic feedback to the user at the work surface based on the position of the user's hand.

13. The device of claim 12 wherein the haptic feedback system provides haptic feedback to the user when the user's hand is located on a horizontal or vertical axis in line with a point of interest.

14. The device of claim 1 further comprising control buttons operatively connected to the control system for allowing the user to provide commands to the control system.

15. The device of claim 5 wherein the magnetic implement is worn on the user's finger.

16. The device of claim 15 wherein the magnetic implement is a removable finger pad.

17. The device of claim 16 wherein the removable finger pad is a finger cot.

18. The device of claim 5 wherein the magnetic implement is a metallic stylus.

19. The device of claim 1 wherein each magnet is positioned on a ferrous plate or cup to redirect the magnet's magnetic field.

20. The device of claim 1 further comprising a computer system having a second display operatively connected to the device for allowing a second user to monitor the display output on the work surface and to input data into the computer system for display on the work surface.

21. A device for allowing a user to interface with spatial data comprising:
an enclosure having a top side with a work surface for displaying spatial data, the work surface comprising a visual display for providing visual information at the work surface;
an array of independently actuatable permanent magnets located below the work surface for representing the spatial data as magnetic fields detectable by the user at the work surface, wherein each magnet includes a linear actuator for actuating the magnet by moving the magnet closer to the work surface;
a control system operatively connected to the array of independently actuatable magnets for controlling the actuation of each magnet;
an audio input system operatively connected to the control system for receiving voice commands from a user and wherein the control system interprets the voice commands to later the display of spatial data;
an audio output system operatively connected to the control system for providing audio output to the user and wherein the control system generates audio output information based on the display of spatial data and the position of the user's hand at the work surface;
a motion capture system operatively connected to the control system for capturing the movement of the user's hand over the work surface and wherein the control system provides further output information to the user based on the position of the user's hand;
a haptic feedback system operatively connected to the control system and to the work surface for providing haptic feedback to the user at the work surface based on the position of the user's hand; and
a magnetic implement for enabling the user to detect magnetic fields at the work surface.
